(19) United States
(12) Patent Application Publication
(10) Pub. No.: US 2010/0179909 A1
(43) Pub. Date: Jul. 15, 2010

(54) USER DEFINED UDK

(76) Inventor: Jubin Dana, Menlo Park, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/353,780

(22) Filed: Jan. 14, 2009

(51) Int. Cl. H04L 9/32

(52) U.S. Cl. 705/67; 705/50

(57) ABSTRACT

A server computer including a processor and a computer readable medium coupled to the processor. The computer readable medium includes code executable by the processor, where the code includes code for receiving user input, code for forming a concatenated value by concatenating the user input with a data string associated with a portable consumer device, and code for deriving the user defined key from the concatenated value.

### BACKGROUND

As methods and devices for engaging in payment transactions have increased, problems such as fraud continue to persist. One way to reduce fraud in a payment transaction is to authenticate the payment card, or other portable consumer device, that is being used to conduct the payment transaction.

Some systems authenticate a portable consumer device using a verification value such as a dynamic card verification value (dCVV). In one exemplary conventional system, at the front end of the transaction (e.g., where the merchant and the consumer reside), the portable consumer device can generate a first dCVV based on a counter value that changes after every transaction. The dCVV is transmitted from the front end of the transaction to a computer at the back end of the transaction. The back end of the transaction may include a payment processing network or an issuer associated with the portable consumer device. The computer at the back end of the transaction can independently generate a second dCVV using a counter value that is received from the front end of the transaction or that is maintained at the back end computer. To verify that the portable consumer device is authentic, the back end computer compares the second dCVV to the received first dCVV. If the values match, or are otherwise acceptable, the portable consumer device is considered authentic. If the first and second dCVVs do not match, then the portable consumer device that is being used in the transaction may not be an authorized portable consumer device, and the transaction may be considered fraudulent.

The dCVVs may be generated using unique derived keys (UDKs). UDKs are encryption keys that are derived using consumer-specific information such as an account number and service code associated with a portable consumer device such as a payment card. Since UDKs are unique to each consumer, encryption processes that use such UDKs are also unique.

Although conventional dCVV processes work well, they could be improved. For example, an issuer (e.g., a bank that is associated with a portable consumer device) may use an account number and service code as input elements for a UDK. If an unauthorized person can determine that these two specific input elements are used to generate UDKs for the issuer's customers, the unauthorized person could potentially determine the verification values. Once the unauthorized person has possession of the algorithm for creating the verification values, it may be possible for the unauthorized person to conduct unauthorized transactions.

Embodiments of the disclosure address the above problems, and other problems, individually and collectively.

### SUMMARY

Systems and methods for encrypting data are disclosed. More specifically, embodiments of the invention relate to methods and systems for generating one or more user defined unique derived keys (UDKs). The user defined UDKs can be used to generate verification values such as dynamic verification values (dCVVs), which are used to authenticate portable consumer devices used in payment transactions.

One embodiment of the invention is directed to a server computer comprising a processor and a computer readable medium coupled to the processor. The computer readable medium comprises code executable by the processor. The computer readable medium comprises code for receiving user input, code for forming a concatenated value by concatenating the user input data with a data string associated with a portable consumer device, and code for deriving the user defined key from the concatenated value.

Another embodiment of the invention is directed to a method for deriving a user defined key. The method comprises receiving user input data and forming, using a processor, a concatenated value by concatenating the user input data with a data string associated with a portable consumer device. The method further comprises deriving the user defined key from the concatenated value using the processor.

Another embodiment of the invention is directed to a method comprising: providing user input data to a service provider; and using a device to conduct a transaction, wherein the portable consumer device comprises a processor; and a computer readable medium coupled to the processor, wherein the computer readable medium comprises code executable by the processor, the computer readable medium comprising (i) code for receiving user input data, (ii) code for forming a concatenated value by concatenating the user input with a data string associated with a portable consumer device, and (iii) code for deriving a user defined key from the concatenated value.

Another embodiment of the invention is directed to a portable consumer device comprising: a processor; and a computer readable medium coupled to the processor, wherein the computer readable medium comprises code executable by the processor, the computer readable medium comprising: code for receiving user input data; code for forming a concatenated value by concatenating the user input with a data string associated with a portable consumer device; and code for deriving a user defined key from the concatenated value.

These and other embodiments of the invention are described in further detail below.

### BRIEF DESCRIPTION OF THE DRAWINGS

FIG. 1 is a block diagram of an exemplary system according to an embodiment of the invention.

FIG. 2 is a flowchart illustrating a method of generating user defined UDKs from user input data.

FIG. 3 shows a method of creating an encrypted data block.

FIG. 4 shows a flowchart for extracting portions of an encrypted data block for creating a dynamic card verification value.

FIG. 5 depicts an exemplary record format.

FIG. 6 depicts an alternative exemplary format.

FIG. 7 is a flowchart of a preferred method of utilizing a dynamically created verification value to authenticate a transaction.

FIG. 8 is a flowchart of an alternate method of utilizing a dynamically created verification value to authenticate a transaction.

FIGS. 9(a) and 9(b) respectively show portable consumer devices in the form of a mobile communication device and a card.

FIG. 10 is a block diagram of subsystems that may be present in computer apparatuses that are used in system, according to embodiments of the invention.

### DETAILED DESCRIPTION

Embodiments of the invention are directed to methods and systems for generating one or more user defined UDKs that can be used to generate verification values, which can be used to authenticate transactions.

One embodiment of the invention is directed to a method for deriving a user defined encryption key, comprising receiving user input data; forming, using a processor, a concatenated value by concatenating the user input data with a data string associated with a portable consumer device; and deriving the user defined encryption key from the concatenated value using the processor. The user defined encryption key may be used to generate a first verification value at a front end (e.g., at a portable consumer device or at an access device) of a payment transaction, as well as a second verification value at a back end of a payment transaction (e.g., at a server computer operated by a payment processing network or an issuer). The portable consumer device can be authenticated if the first and second verification values match or are otherwise within an acceptable range.

Illustratively, a consumer may initiate a purchase of an item at a merchant. The consumer may take his portable consumer device (e.g., a smart card) and may pass it by or through an access device (e.g., point of sale terminal) at the merchant. A first verification value may be generated using the portable consumer device or the access device. The first verification value may be derived from a user defined encryption key, which is generated using input data that is specifically provided by the user.

Before or after the purchase transaction is initiated, the consumer may be prompted to provide the input data to the portable consumer device, access device, and/or a back end server computer residing at a payment processing network or an issuer. For instance, the input data can be provided by the consumer through the portable consumer device if it has an appropriate user interface. It may alternatively be provided by the consumer through a client computer, which can communicate with the back end computer and/or the portable consumer device. The input data could reside in a memory in the portable consumer device and/or in a database coupled to a backend computer operated by a payment processing network, issuer, or the like.

Before or when a transaction is conducted, the portable consumer device or the access device combines the received input data with other data such as the consumer's account number to form a concatenated value. The concatenated value can be encrypted with a master key, and the encrypted data can be used to generate one or more user defined UDKs.

The one or more user defined UDKs may be used to generate verification values such as dynamic card verification values. The one or more UDKs may be stored in or generated by the portable consumer device or the access device at the front end of the transaction. A first verification value is then generated using the one or more user defined UDKs. After it is generated, the first verification value is embedded in track data and is sent to the back end computer in an authorization request message.

After the back end computer receives the first verification value, the back end computer also determines the one or more user defined UDKs with the input data. The back end computer can receive the input data in a discretionary data field in the authorization request message (or the like), or may receive the input data through another data channel (e.g., via the Internet using a client computer). The back end computer then generates the one or more user defined UDKs if they have not yet been previously generated by the back end computer.

The back end computer then uses the one or more user defined UDKs to generate a second verification value. The back end computer then compares the first and second verification values. If the first and second verification values match or are otherwise acceptable, then the portable computer device may be considered authentic. The back end computer may then send an appropriate message to the merchant, consumer, and/or issuer indicating that the portable consumer device that is being used in the transaction is authentic.

Embodiments of the invention are advantageous. An advantage to consumers, issuers, and payment processors is that transactions can be conducted more securely. As noted above, in embodiments of the invention, one or more user defined UDKs can be created using information provided by consumers. The one or more user defined UDKs are used to produce verification values that can be used to authenticate transactions. By allowing the consumer to provide the input data used to create the one or more user defined UDKs, the one or more user defined UDKs are more unique than UDKs that are created using predetermined data that are not selected by the consumer. This makes it more difficult for an unauthorized user to duplicate the user defined UDKs, and therefore makes it more difficult for the unauthorized user to determine the verification values. Embodiments of the invention are thus more secure than conventional systems, and can reduce lost revenue due to fraudulent transactions.

Embodiments of the invention may include none, some, or all of these advantages. One or more other technical advantages may be readily apparent to one skilled in the art from the figures, descriptions, and claims included herein.

### I. Exemplary Systems

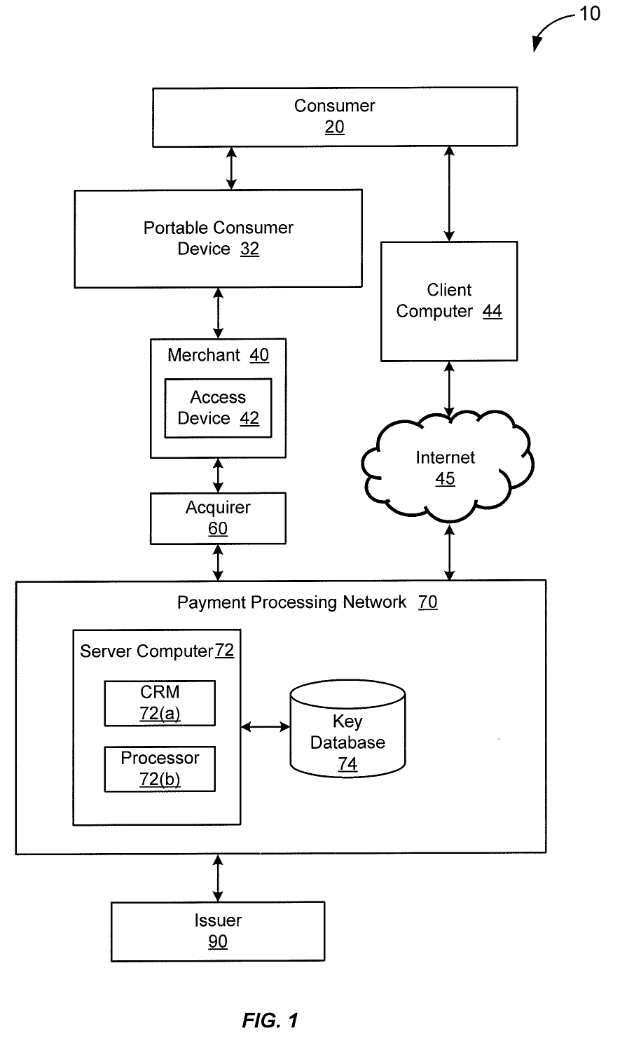

FIG. 1 is a block diagram of an exemplary system 10 according to an embodiment of the invention. Although FIG. 1 shows a number of components, the system 10 according to embodiments of the invention may comprise any suitable combination or subset of such components.

The system 10 includes a consumer 20 that uses a portable consumer device 32 (e.g. a smart card) having a computer readable medium (not shown in FIG. 1). Specific examples of portable consumer devices are provided below.

The system 10 also includes a merchant 40 associated with an access device 42 (e.g., a point-of-sale terminal). The portable consumer device 30 can communicate with the access device 42 when a purchase transaction is conducted. The system 10 also includes an acquirer 60 (e.g., a bank) associated with the merchant 40.

The system 10 also includes a payment processing network 70 having a server computer 72 in communication with a key database 74. The system 10 also includes an issuer 90 that maintains an account associated with the consumer 20 and the portable consumer device 32. Some examples of issuers may be a bank, a business entity such as a retail store, or a governmental entity.

The merchant 40 can be any suitable type of entity. Some examples of merchants include a department store, a gas station, a drug store, a grocery store, etc.

The access device 42 can be any suitable device capable of communicating with the portable consumer device 30. Examples of suitable devices include point of sale (POS) terminals, mobile phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, websites, and the like. Access device 42 may use any suitable contact or contactless mode of operation to communicate data to and from portable consumer device 30.

The payment processing network 70 may include data processing subsystems, networks, and operations used to support and deliver authorization services, exception file services, and clearing and settlement services. An exemplary payment processing network 70 may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

In FIG. 1, the payment processing network 70 includes a server computer 72 which is an example of a back end computer. Although FIG. 1 shows the server computer 70 residing in the payment processing network 70, it may alternatively reside at the issuer 90 in other embodiments of the invention.

A “server computer” can refer to a computer or cluster of computers. For example, the server computer 72 can be a large mainframe, a minicomputer cluster, or a group of servers functioning as a unit. In one example, the server computer 72 may be a database server coupled to a Web server (not shown). The payment processing network 70 may use any suitable wired or wireless network, including the Internet.

As shown in FIG. 1, the server computer 72 has a CRM 72(a) in communication with a processor 72(b). The CRM 72(a) comprises code for performing the functions of server computer 72, while the processor 72(b) executes the code to perform the functions of server computer 72. Some examples of code stored in the CRM 72(a) include code for generating user defined UDKs from user input data, code for receiving user input data from the consumer 20, code for generating verification values from the user input data, etc. The code stored on the CRM 72(a) could also be stored on a computer readable medium residing in the portable consumer device 30, the access device 42, a computer at the issuer 90, or the client computer 44, as any of these devices may be used to receive user input data and/or generate verification values using the user input data.

The payment processing network 70 also includes a key database 74 in communication with the server computer 72. In some cases, the user defined UDKs can be temporarily or permanently stored in the key database 74. In other cases, the user defined UDKs may be generated with each transaction and it may not be necessary to store them in a key database.

The consumer 20 may also communicate with the server computer 72 at the payment processing network 70 using a client computer 44, via a data network such as the Internet 45. The client computer 44 may be a personal computer such as a laptop computer, phone, personal digital assistant, or other device capable of processing data. It may include a standard Internet browser, and other suitable software for communication with host sites via the Internet.

As explained below, user defined UDKs are generated using user input data that are provided by the consumer (or user). The user input data may be provided to the system 10 in any suitable manner. For example, in one embodiment, the user input data may be provided to the portable consumer device 32 directly by the consumer 20, if the portable consumer device 32 has an appropriate user interface. Alternatively or additionally, the consumer can use the client computer 44 to enter the user input data into the portable consumer device 32 if the portable consumer device 32 is capable of receiving data from the client computer 44.

In another example, the consumer 20 may provide the user input data to the server computer 72 using the client computer 44. The user input data can be received by the server computer 72 in the payment processing network 70 or at the issuer 90. Once the user input data is received at the payment processing network 70 or the issuer 90, the payment processing network 70 or the issuer 90 may use it to generate user defined UDKs, and verification values using the user defined UDKs. Additionally or alternatively, after the issuer 90 receives the user input data, it may load the user input data into a memory in the portable consumer device 32, and may thereafter issue it to the consumer 20. At this point, the portable consumer device 32 may contain the user input data so that it may generate user defined UDKs and verification values.

### II. Exemplary Methods for Generating User Defined UDKs

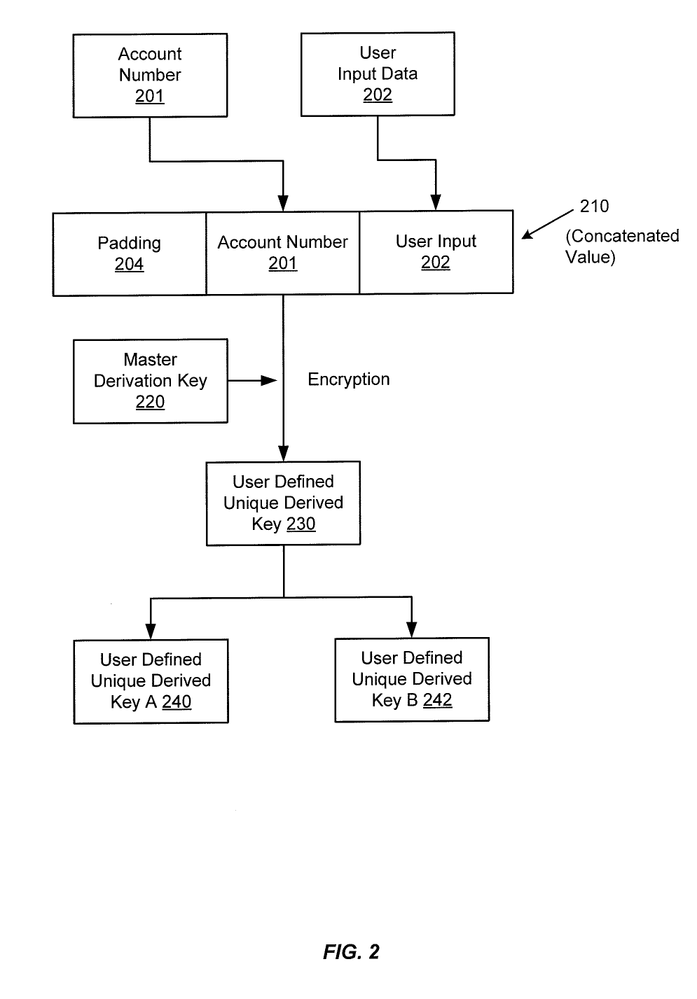

FIG. 2 is a flowchart illustrating a method of generating user defined UDKs 240 and 242 from user input data 202 and an account number 201. The account number 201 may be an example of a data string associated with a portable consumer device. User input data is typically data that is specifically selected by a holder of a portable consumer device (as opposed to being selected by an issuer).

Any suitable type of user input data may be used in embodiments of the invention. The user input data may, or may not, also be directly associated with the portable consumer device, and the data may be static or dynamic in nature. For example, the user (or consumer) could specifically select one or more of the following pieces of data to generate one or more user defined UDKs: an account number, a PIN (personal identification number), an expiration date for a portable consumer device, a service code, etc., or any combination thereof. In other embodiments, the user input data may be unrelated to the portable consumer device being used. For example, the user input data can include data such as: a social security number, a marriage date, birthday of a relative or the holder of the portable consumer device, a numerical portion of the address of the holder's residence, the holder's zip code, etc., or any combination thereof.

The data string associated with the portable consumer device may be directly related to the portable consumer device. Such information may include, for example, an account number, a PIN (personal identification number), an expiration date for a portable consumer device, a service code, etc., or any combination thereof. The data string associated with the portable consumer device may be selected by the issuer, organization that operates the payment processing network, or the consumer.

In FIG. 2, one or more padding characters 204 (if necessary), account number 201 (e.g., a PAN), and user input data 202 are concatenated together to form a concatenated value 210 of a predetermined length. The concatenated value 210 can be of any suitable predetermined length (e.g., 128-bits or 64 bits). In some cases, padding characters 204 may not be necessary if characters of the account number 201 and the user input data 202 provide the predetermined length. Padding characters 204 can be of any suitable value such as “0,” “1,” or the like.

The concatenated value 210 is then encrypted using a master derivation key 220. Any suitable encryption methodology may be used. For example, an encryption step may utilize a DES, Triple-DES, or other suitable encryption methodology. The user defined UDK 230 is generated as a result of encrypting the concatenated value 210.

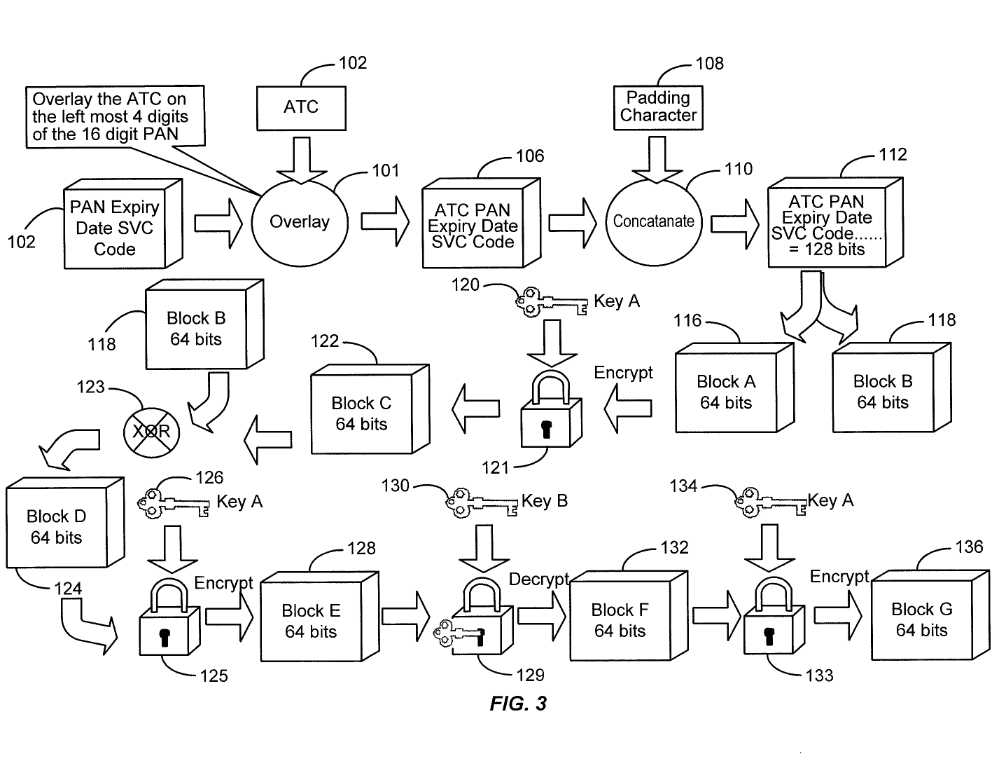

If desired, additional user defined UDKs may be generated from the user defined UDK 230. For example, as shown in FIG. 2, a first user defined UDK 240 and a second user defined UDK 242 are derived from the user defined UDK 230. The first user defined UDK 240 and the second user defined UDK 242 can be of any suitable length (e.g., they may be of equal or unequal length). Although FIG. 3 shows two user defined UDKs 240 and 242 being derived from user defined UDK 230, other embodiments may include deriving one user defined UDK or three or more user defined UDKs from the user defined UDK 230.

Any suitable method can be used to derive first user defined UDK 240 and second user defined UDK 242. In one method, for example, the leftmost half of the user defined UDK 230 may be assigned to the first user defined UDK 240 and the rightmost half of the user defined UDK 230 assigned to the second user defined UDK 242. In another example, the first user defined UDK 240 may be derived by selecting alternating or other predetermined bit sequences from user defined UDK 230. The second user defined UDK 242 may be derived from remaining bit sequences or other predetermined bit sequences.

In some embodiments, since the user defined UDKs 230, 240, 242 may be derived from both data that are selected by the issuer (e.g., the account number 201) and data that are selected by the user (e.g., the user input data 202), it is very difficult for an unauthorized person to derive the user defined UDKs 230, 240, 242. For example, in order to determine the user defined UDKs 230, 240, 242, any unauthorized person would have to know: a) the data selected by the consumer, b) the data selected by the issuer, c) the master derivation key, and d) other aspects of the encryption process. Since it is unlikely that the user defined UDKs can be reproduced by an unauthorized person, it is highly unlikely that the verification values generated using the user defined UDKs can be generated by the unauthorized person.

### III. Exemplary Methods for Generating Verification Values Using User Defined UDKs

Exemplary methods for generating verification values can now be described. However, it may be helpful to first elaborate on some terms that can be used in the description of such methods.

For purposes of this application, the term “payment service” can include any application deployed on a portable consumer device which causes the exchange of data between the portable consumer device and any other device or location.

For purposes of this application, “payment data” can include, with respect to financial applications, those data elements used by the payment service to execute a transaction, and with respect to non-financial transactions any necessary data elements exclusive of the present invention. For example, when the payment service is a magnetic stripe credit card transaction, “payment data” would comprise Track 1 and/or Track 2 data, as that is understood by one of ordinary skill in the credit card industry, such as the primary account number, expiration date, service codes, and discretionary data. “Payment data” may also comprise a unique card identification number or a unique identification number for a service provider.

As used herein, a “service provider” can be any entity that provides a service during a transaction. For example, a service provider may be an entity that verifies that a dynamic verification value is authentic. Examples of service providers include payment processing organizations, and issuers.

In an embodiment of the invention, the payment data may reside in memory located in the portable consumer device. The portable consumer device may also maintain an application transaction counter (ATC), which may be a value of any suitable length. The ATC may initially be set by the service provider to a predetermined value. Thereafter, the ATC may be incremented with each transaction. Alternately, the ATC may be decremented from its initial predetermined value with each transaction. In addition, the service provider which deployed the payment service may maintain a corresponding ATC accessible to the service provider's computer. As discussed in more detail below, this corresponding ATC is used to identify payment services which may have been skimmed. In an alternate embodiment, a cryptogram, digital signature, or hash value based on transaction data may be used in place of or in conjunction with the ATC.

Methods for generating dCVVs using the above-described user defined UDKs can be described with reference to FIGS. 3-8.

Referring to FIG. 3, each time a payment is initiated, a dCVV is generated on the portable consumer device for authentication purposes. Initially, a numeric string of predetermined length is created. This numeric string is created by overlaying 101 the ATC (automatic transaction counter) 102 over the corresponding leftmost digits of the account number for the payment service or PAN (primary account number) 104. This numeric string is concatenated on the right with the expiration date for the payment service and the service code to produce a concatenated value 106. If necessary, padding characters 108 are concatenated 110 on the right of the concatenated value 106 to form a numeric string 112 with a predetermined fixed length. In one embodiment, this numeric string 112 is 128-bits in length, although a numeric string of any length may be used. The padding characters 108 may consist of a stream of 0's, 1's, or any other numeric value that is known both to the portable consumer device and the service provider. The numeric string 112 is bisected into two blocks of equal length, Block A 116 and Block B 118. Block A 116 is then encrypted 121 with a first user defined encryption key 120. The result of the encryption step 121 is Block C 122 of length equal to Block A 116. Block C 122 is then exclusively OR'ed (XOR) 123 with Block B 118 resulting in Block D 124. Block D 124 is then encrypted 125 with a second user defined encryption key 126 to produce Block E 128. Block E 128 is then decrypted 129 using a user defined decryption key 130 to produce Block F 132. Block F 132 is then encrypted 133 using a fourth user defined encryption key 134 to produce Block G 136.

It will be apparent to one of ordinary still in the art that the first key 120, the second key 126, the third key 130 and the fourth key 134 may have any preselected value. In an embodiment of the present invention, the first key 120, the second key 126, and the fourth key 134 are equivalent and of a different value from the third key 130.

In some embodiments, upon deployment, each payment service on each portable consumer device can be personalized by the service provider with a master derivation key. The master derived key may be deployed with payment services in batches (i.e. multiple payment services receive the same master derived key) or individually. Each portable consumer device may be personalized with the functionality to derive keys unique to the payment service. This personalization may include incorporation of the previously described user input data.

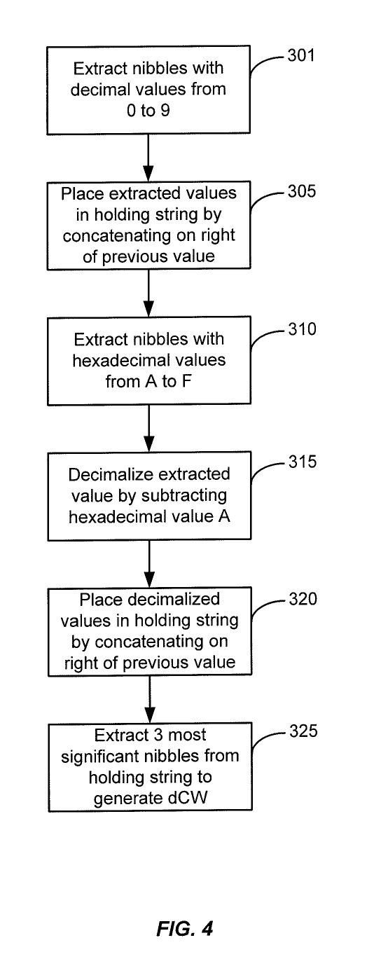

FIG. 4 describes the further processing for generating a dCVV. Each nibble (4-bit grouping) of the value stored in Block G 136 is subjected to two separate iterative processes to evaluate the value of each nibble. As shown in FIG. 4, beginning with the most significant (i.e. left most) digit of Block G 136 and examining each sequential nibble, if a nibble contains a value ranging from zero to nine, inclusive, that value is extracted 301 and placed in a new numeric string 305, referred to herein as a holding string, by concatenating the extracted value to the right of the previously extracted value, if any. The result may be that the holding string contains a series of values ranging from zero to nine, inclusive, which appear from left to right in the holding string in the same sequence in which they appear in Block G 136.

A second evaluation is then performed again beginning with the most significant digit of Block G 136 and examining each sequential nibble. If a nibble contains a hexadecimal value ranging from ten (A) to fifteen (F), inclusive, that value is extracted 310. The extracted value is then decimalized by subtracting the hexadecimal value A from the extracted value resulting in a decimalized value ranging from zero to five 315. This decimalized value is then concatenated on the right to the right most value of the holding string 320.

Once all nibbles in Block G have been twice examined as described, the three most-significant (i.e. left-most) nibbles of the holding string are extracted 325. This 3-digit value is the dCVV for the transaction. Other numbers of bits may be extracted from the twice-examined nibble string to generate the dCVV for a transaction. Furthermore, different nibbles, such as the rightmost nibbles, may be used as the dCVV for a transaction. The three leftmost nibbles, however, represent a preferred embodiment.

Once generated, the dCVV is embedded into the payment data transmitted from the portable consumer device to the point of sale terminal (e.g., in an authorization request message). The data received by the point of sale terminal may appear to the point of sale terminal as standard payment data. In other words, the point of sale terminal may not be able to determine if a dCVV is embedded and where such dCVV may be located. There is no indication to the point of sale terminal that a dCVV is embedded into the data received from the portable consumer device.

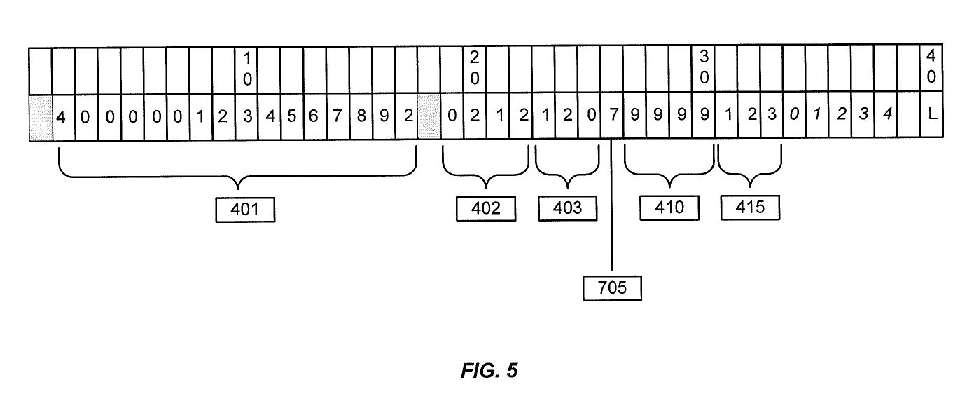

FIG. 5 depicts an exemplary record format for transmitting payment data, with the dCVV embedded therein, from the portable consumer device to the point of sale terminal. The record format of FIG. 4 is created by concatenating a primary account number 401 for the payment service, with an expiration date 402, and a service code 403. In one embodiment, the primary account number 401 is 16 digits long, the expiration date 402 is four digits long, and the service code 403 is three digits long. However, the primary account number 401, the expiration date 402, and the service code 403 are not limited to being these lengths. Next, in a field typically reserved for other uses, a value is placed as an indicator 705 that a dCVV has been embedded in this record. The value of this indicator is known by the service provider which deployed the application on the portable consumer device. Next, the ATC 410 is placed in the field which may typically be reserved for PIN verification data. Finally, the dCVV 415 is concatenated on the right of the record. The remainder of the record may comprise additional discretionary data.

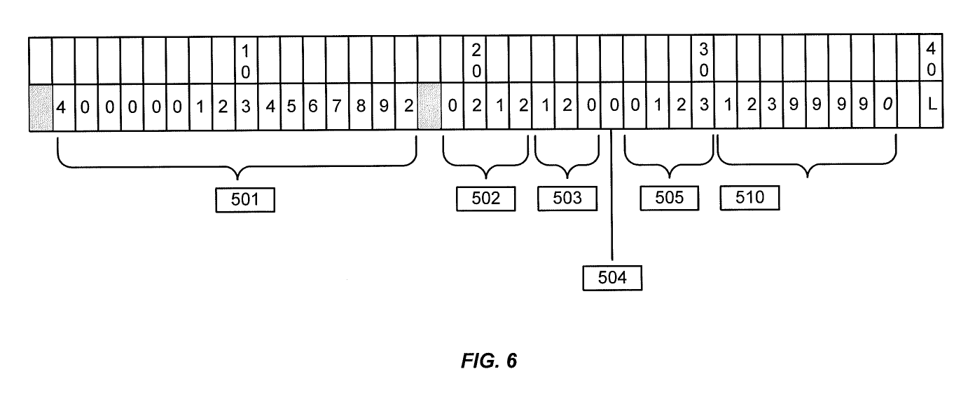

Alternately, FIG. 6 depicts a second exemplary format for transmitting payment information with the dCVV embedded thereon from the portable consumer device to the point of sale terminal. The format in FIG. 6 is created by concatenating a primary account number 501 for the payment service, with an expiration date 502, a service code 503, a PVKI 504, and a field for PIN verification data 505. In one embodiment, the primary account number 501 is sixteen digits long, the expiration date 502 is four digits long, the service code 503 is three digits long, the PVKI 504 is one digit long, and the PIN verification data 505 is four digits long. However, the primary account number 501, the expiration date 502, the service code 503, the PVKI 504, and the PIN verification data 505 are not limited to being these lengths. Next, in a single data field 510 each of the dynamically created CW, the ATC and the indicator to be used by the service provider to identify that a dynamic CW has been embedded are stored in sequence. The remainder of the record may comprise additional discretionary data.

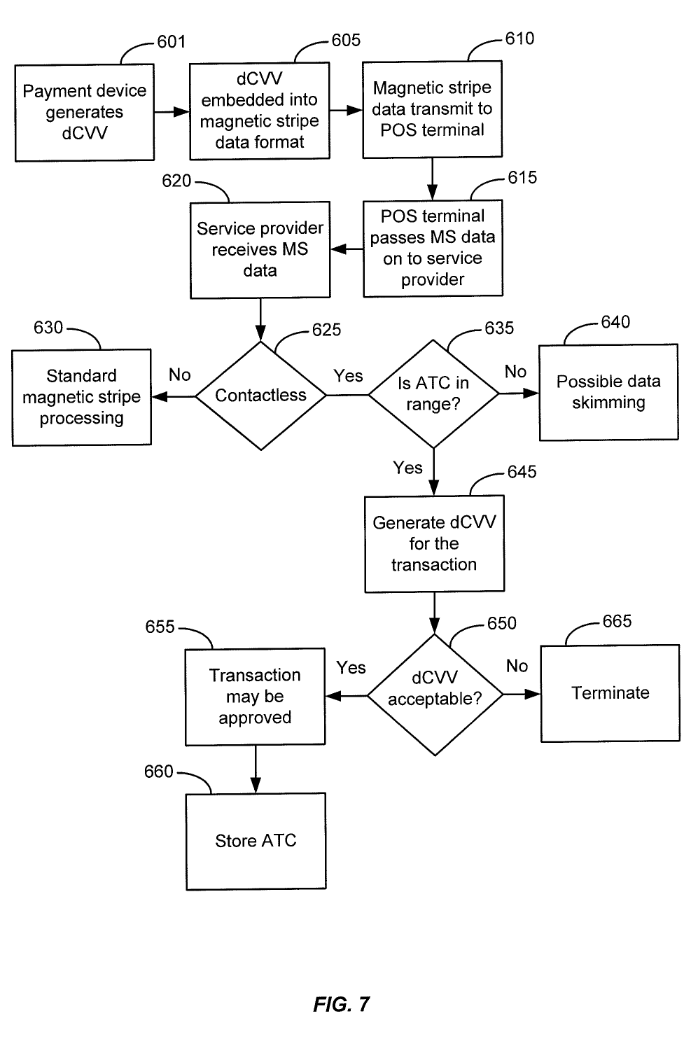

An aspect of embodiments of the present invention is that the system of utilizing the dynamically created CW allows the service provider to make a determination of the authenticity of the payment service being utilized. This authentication step is not left to merchants, individual point of sale terminals, or other third parties or devices. FIG. 7 shows how the dCVV is used in a contactless environment to permit the service provider to evaluate the authenticity of the payment application deployed on the portable consumer device to make a determination of whether the payment application has been skimmed. Although shown in the embodiment of a contactless environment in FIG. 7, the present invention is not limited to such an environment and may be used for any transaction where magnetic stripe Track 1 and/or Track 2 data is exchanged using any method or means for communicating such data.

As shown in FIG. 7, the portable consumer device generates the dCVV 601, using the methodology described above. The dCVV is embedded into the payment data 605. In this respect, the exemplary record formats shown in FIG. 5 or FIG. 6 may be utilized. The payment data with the embedded dCVV is transmitted by data communication to the point of sale terminal 610. The point of sale terminal recognizes the received data as in the standard format of payment data and passes the data stream on to the service provider computer 615, likely via a payment network (not shown). The service provider computer receives 620 the payment data with the embedded dCVV and interrogates the appropriate indicator to determine if the transaction was a contactless transaction or not 625. If the service provider computer determines that the transaction was not a contactless transaction, the transaction is processed in its normal manner 630. If the service provider computer determines that the transaction was contactless, the service provider computer compares the ATC received from the portable consumer device to the corresponding ATC on the service provider computer to determine if the received ATC is the expected next ATC 635, and/or is within an allowable range. If the ATC received from the portable consumer device is not the expected next ATC or within the allowable range, the payment service deployed on the portable consumer device has potentially been skimmed 640. If the expected next ATC and/or an ATC that is within the allowable range is received, the service provider computer may independently re-generate the dCVV for the given transaction 645 utilizing a similar or analogous process as described above. If the service provider generated dCVV matches the dCVV received from the portable consumer device 650, or if the dCVV is one that can be generated using an ATC within the allowable range, the service provider deems the payment application to be authentic 655. The service provider computer then replaces the ATC which was previously stored on the service provider computer with the generated ATC received from the portable consumer device 660 for subsequent authentications. If the service provider generated dCVV does not match the dCVV, or is not one which is derived from an ATC within the allowable range, the transaction is potentially fraudulent and is terminated 665.

The methodology of FIG. 7 discussed in conjunction with contactless transactions, is not limited thereto. For example, the methodology may be utilized with respect to transactions above a certain threshold value. In such an instance, the service provider, upon deploying the application, would configure the application to generate a dCVV for transactions above the threshold. The indicator interrogated in Step 625 would then be set for transactions above the threshold value. Similarly, the methodology may be utilized with respect to any other transaction criteria including, but not limited to, geographic location, use patterns, or any other criteria.

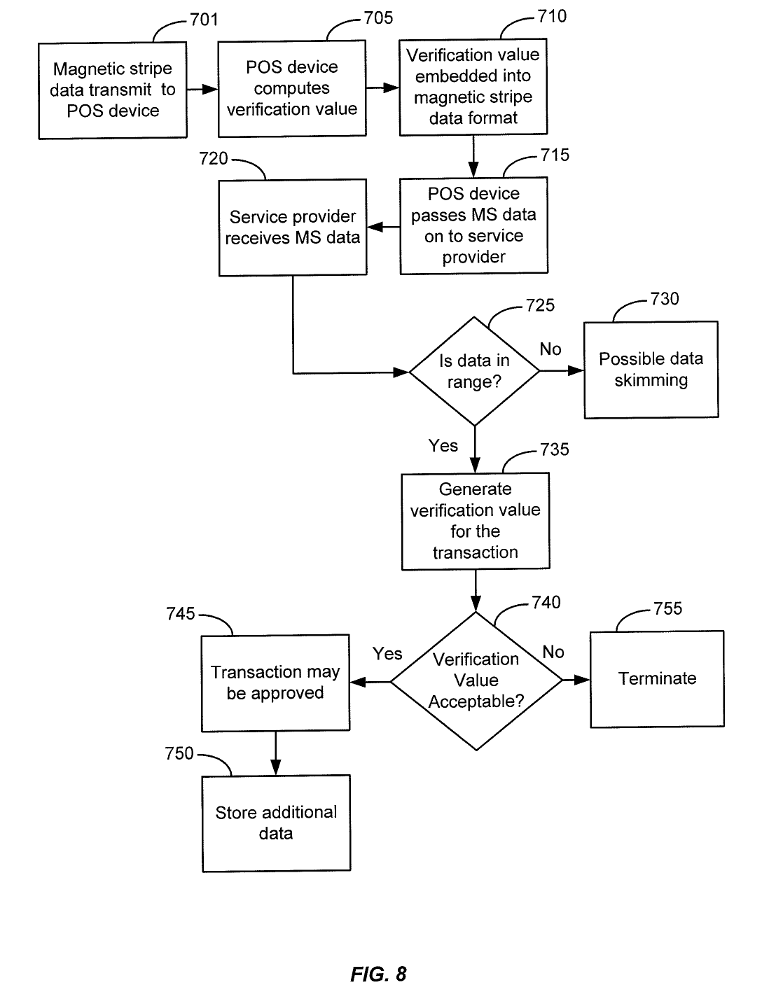

Referring to FIG. 8, in an alternate embodiment, the portable consumer device transmits payment data to a point of sale terminal such as a credit card terminal 701. The point of sale terminal receives the data and computes a verification value for the transaction 705. The verification value may be computed in a number of different ways including, without limitation, using a unique transaction number provided by the point of sale terminal, a timestamp, or a transaction amount added to a timestamp. The point of sale terminal may then embed and/or append the verification value and additional data to the payment data 710. The additional data may be required for the service provider computer to verify the transaction. The point of sale terminal then passes the data stream on to the service provider computer 715, likely via a payment network (not shown). The service provider computer receives the payment data with the verification value 720. The service provider computer may optionally compare at least a portion of the additional data embedded or appended by the point of sale terminal to corresponding data stored on the service provider computer to determine if the received data is proper 725, and/or is within a predetermined range. If the received data from the point of sale terminal is improper, the transaction data may potentially have been skimmed 730. If proper data, the service provider computer may independently re-generate the verification value for the given transaction utilizing the same process as used by the point of sale terminal 735. If the service provider generated verification value matches the verification value received from the point of sale terminal 740, of if the generated verification value is otherwise acceptable (e.g., the verification value is generated using dynamic data elements that are within acceptable ranges), the service provider deems the payment application to be authentic 745. The service provider computer may then optionally update the additional data which was previously stored on the service provider computer with the additional data received from the portable consumer device for subsequent authentications 750. If the service provider generated verification value does not match the verification value received from the point of sale terminal, or is otherwise not acceptable, the transaction is potentially fraudulent and is terminated 755.

### IV. Portable Consumer Devices and Computer Apparatuses

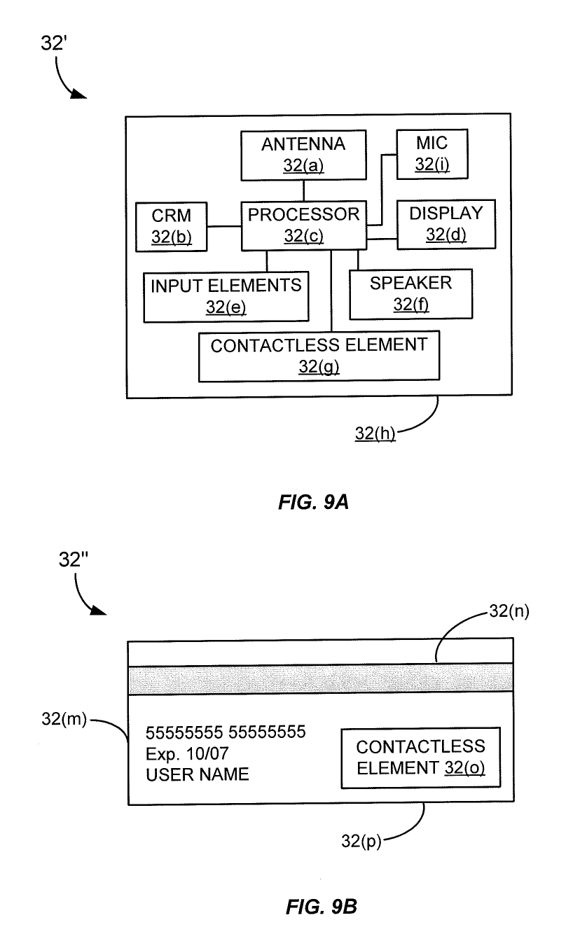

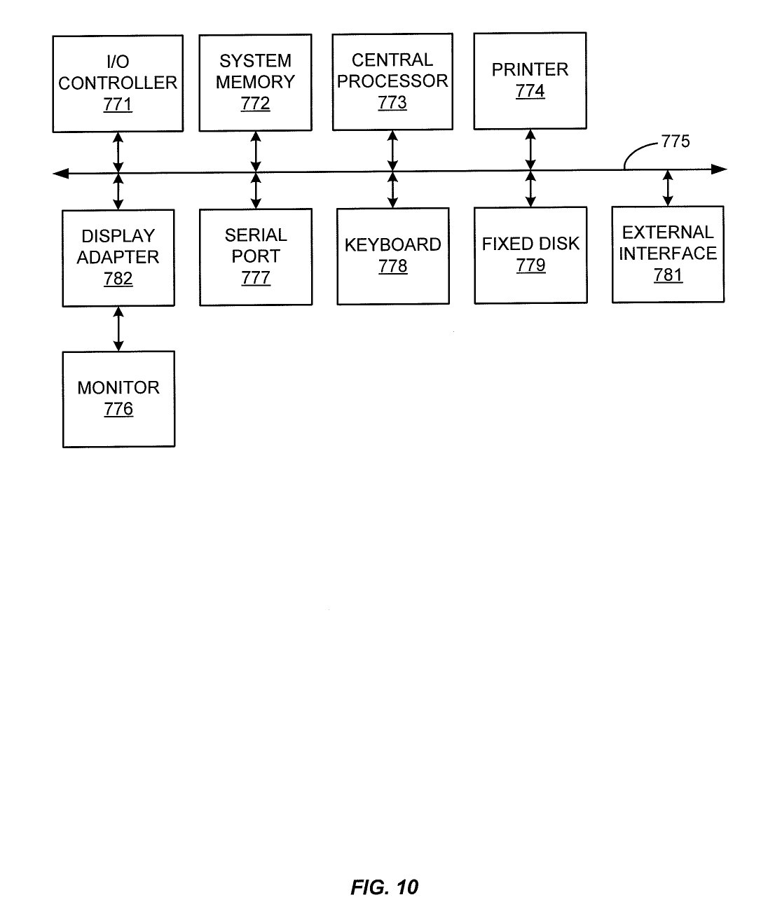

FIGS. 9-10 show block diagrams of portable computer devices and subsystems that may be present in computer apparatuses in systems according to embodiments of the invention.

The portable consumer device may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

An exemplary portable consumer device 32′ in the form of a phone may comprise a computer readable medium and a body as shown in FIG. 9A. (FIG. 9A shows a number of components, and the portable consumer devices according to embodiments of the invention may comprise any suitable combination or subset of such components.) The computer readable medium 32(b) may be present within the body 32(h), or may be detachable from it. The body 32(h) may be in the form a plastic substrate, housing, or other structure. The computer readable medium 32(b) may be a memory that stores data and may be in any suitable form including a magnetic stripe, a memory chip, uniquely derived keys (such as those described above), encryption algorithms, etc. For example, the memory may store code for receiving user input data; code for forming a concatenated value by concatenating the user input with a data string associated with a portable consumer device; and code for deriving a user defined key from the concatenated value. The memory also preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the portable consumer device 32.

Information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable consumer device 32 may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 32 and data or control instructions transmitted via a cellular network may be applied to contactiess element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth , infra-red, or other data transfer capability that can be used to exchange data between the portable consumer device 32 and an interrogation device. Thus, the portable consumer device 32 is capable of communicating and transferring data and/or control instructions via both cellular network and near field communications capability.

The portable consumer device 32 may also include a processor 32(c) (e.g., a microprocessor) for processing the functions of the portable consumer device 32 and a display 32(d) to allow a consumer to see phone numbers and other information and messages. The portable consumer device 32 may further include input elements 32(e) to allow a consumer to input information into the device, a speaker 32(f) to allow the consumer to hear voice communication, music, etc., and a microphone 32(i) to allow the consumer to transmit her voice through the portable consumer device 32. The portable consumer device 32 may also include an antenna 32(a) for wireless data transfer (e.g., data transmission).

If the portable consumer device is in the form of a debit, credit, or smartcard, the portable consumer device may also optionally have features such as magnetic strips. Such devices can operate in either a contact or contactless mode.

An example of a portable consumer device 32″ in the form of a card is shown in FIG. 9B. FIG. 9B shows a plastic substrate 32(m). A contactless element 32(o) for interfacing with an access device 34 may be present on or embedded within the plastic substrate 32(m). Consumer information 32(p) such as an account number, expiration date, and consumer name may be printed or embossed on the card. Also, a magnetic stripe 32(n) may also be on the plastic substrate 32(m).

As shown in FIG. 9B, the portable consumer device 32″ may include both a magnetic stripe 32(n) and a contactless element 32(o). In other embodiments, both the magnetic stripe 32(n) and the contactless element 32(o) may be in the portable consumer device 32″. In the other embodiments, either the magnetic stripe 32(n) or the contactless element 32(o) may be present in the portable consumer device 32″.

The various participants and elements in FIG. 1 and the previously described service providers, may operate one or more computer apparatuses to facilitate the functions described herein. Any of the elements in FIG. 1 may use any suitable number of subsystems to facilitate the functions described herein. Examples of such subsystems or components are shown in FIG. 10. The subsystems shown in FIG. 10 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

A computer readable medium according to an embodiment of the invention may comprise code for performing any of the functions described above. For example, the previously described server computer 72 may comprise a computer readable medium comprising code for generating user defined UDKs from user input, code for receiving user input from consumer 20, and code for generating verification values.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

All patents, patent applications, publications, and descriptions mentioned above are herein incorporated by reference in their entirety for all purposes. None is admitted to be prior art.

What is claimed is:

1. A server computer comprising:
a processor; and
a computer readable medium coupled to the processor, wherein the computer readable medium comprises code executable by the processor, the computer readable medium comprising:
code for receiving user input data;
code for forming a concatenated value by concatenating the user input with a data string associated with a portable consumer device; and
code for deriving a user defined key from the concatenated value.

2. The server computer of claim 1, wherein the computer readable medium further comprises code for prompting a consumer associated with the portable consumer device for the user input data.

3. The server computer of claim 1, wherein the data string associated with the portable consumer device includes an account number associated with the portable consumer device.

4. The server computer of claim 1, wherein the computer readable medium further comprises code for generating a dynamic verification value from the user defined key.

5. The server computer of claim 1, wherein the portable consumer device is a payment card.

6. The server computer of claim 1, wherein the user input data includes data that is not specifically associated with the portable consumer device.

7. The server computer of claim 1 wherein the portable consumer device is in the form of a phone.

8. A method for deriving a user defined key, comprising:
receiving user input data;
forming, using a processor, a concatenated value by concatenating the user input with a data string associated with a portable consumer device; and
deriving the user defined key from the concatenated value using the processor.

9. The method of claim 8, further comprising prompting a consumer associated with the portable consumer device for the user input data.

10. The method of claim 8, wherein the data string associated with the portable consumer device includes an account number associated with the portable consumer device.

11. The method of claim 8, further comprising generating a verification value using the user defined key.

12. The method of claim 8, wherein deriving the user defined key from the concatenated value using the processor comprises encrypting the concatenated value with a master derivation key.

13. The method of claim 8, wherein the portable consumer device is a payment card.

14. A method comprising:
providing user input data to a service provider; and
using a device to conduct a transaction, wherein the portable consumer device comprises a processor; and a computer readable medium coupled to the processor, wherein the computer readable medium comprises code executable by the processor, the computer readable medium comprising (i) code for receiving user input data, (ii) code for forming a concatenated value by concatenating the user input with a data string associated with a portable consumer device, and (iii) code for deriving a user defined key from the concatenated value.

15. The method of claim 14 wherein the device is a portable consumer device.

16. The method of claim 14 wherein the device is an access device.

17. The method of claim 14 wherein the user input data is provided to the service provider using a client computer.

18. The method of claim 14 wherein the user input data is provided to the service provider using the device.

19. The method of claim 14 wherein the device is a phone.

20. A portable consumer device comprising:
a processor; and
a computer readable medium coupled to the processor, wherein the computer readable medium comprises code executable by the processor, the computer readable medium comprising:
code for receiving user input data;
code for forming a concatenated value by concatenating the user input with a data string associated with a portable consumer device; and
code for deriving a user defined key from the concatenated value.
